(19) United States
(12) Patent Application Publication
(10) Pub. No.: US 2019/0066490 A1
(43) Pub. Date: Feb. 28, 2019

(54) SMART CITY DATA ANALYTICS FOR IMPROVED ACCIDENT RECONSTRUCTION AND SOLUTIONS

(71) Applicant: Continental Automotive Systems, Inc., Auburn Hills, MI (US)

(72) Inventor: Jeffery Skvarce, Clarkston, MI (US)

(73) Assignee: Continental Automotive Systems, Inc., Auburn Hills, MI (US)

(21) Appl. No.: 16/113,421

(22) Filed: Aug. 27, 2018

Related U.S. Application Data
(60) Provisional application No. 62/551,269, filed on Aug. 29, 2017.

(51) Int. Cl. G08G 1/01; G07C 5/00; G08G 1/052; G08G 1/056; G08G 1/04; G08G 1/015; G08G 1/16

(52) U.S. Cl. CPC G08G 1/0116; G07C 5/008; G08G 1/052; G08G 1/056; G08G 1/166; G08G 1/0133; G08G 1/015; G08G 1/164; G08G 1/04

(57) ABSTRACT

Using object detection in potentially dangerous areas (such as road crossings, intersections, streets with high pedestrian or cyclist activity) and existing vulnerable road user EBA algorithms, the events leading up to a collision, as well as the actual collision event may be recorded such that an accurate account of the accident is achieved, and local law enforcement agencies may be immediately notified. Since EBA systems have sensors that may accurately determine the location, speed, and direction of objects (pedestrians, cyclists, etc), and may be equipped with V2x technologies and communicate with the smart city infrastructures, key information may be obtained and sent to various servers for companies to determine pre-crash scenario accidents occurring in near real-time using cloud type services via cellular, wifi, and other networks, such that developers of safety technologies may use this information quickly implement new safety technologies or improve existing ones.

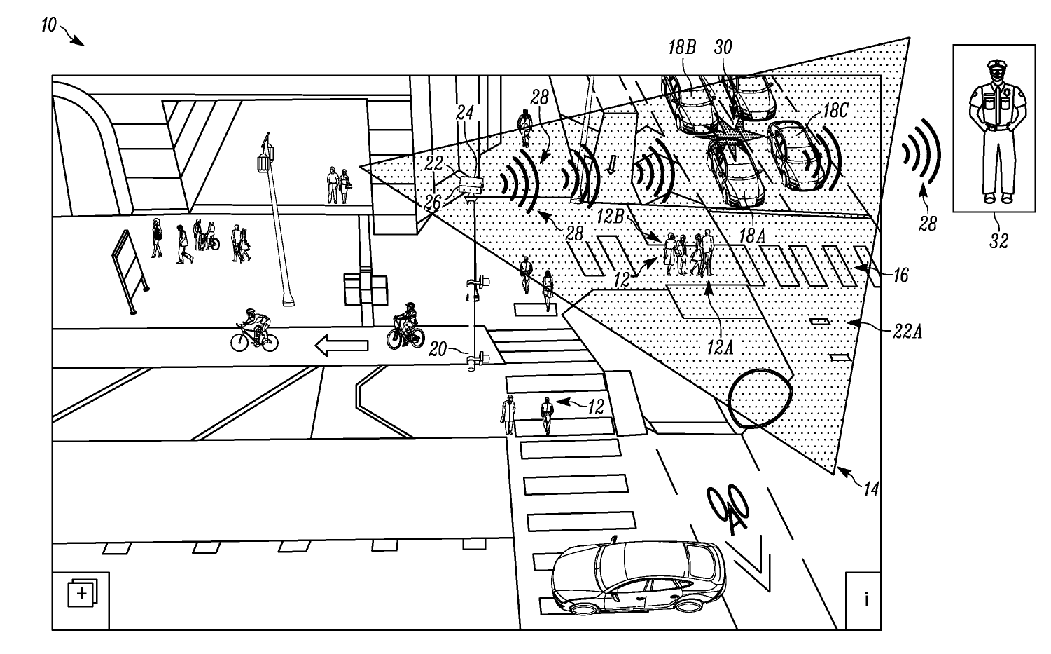

### FIELD OF THE INVENTION

The invention relates generally to a system for providing law enforcement agencies with real time or near real time data of a traffic event, such as an accident, as well as provide data to companies, government agencies, various research institutions, etc, which study accidents such that new safety technologies may be developed, redesigned, and quickly implemented.

### BACKGROUND OF THE INVENTION

Currently, there are many types of systems in place, which are part of a vehicle, to make a driver of the vehicle aware of potential dangers with regard to collisions with pedestrians, other vehicles, and other objects along the side of a road, or on a road. Even with all of these advances in technology, accidents at both signalized and unsignalized intersections still occur. Most often, law enforcement agencies gather information regarding these accidents after they occur, oftentimes by interviewing witnesses, and the drivers of the vehicles. However, these accounts of the accident may not always be accurate, and the information is provided after the accident occurs, instead of providing a real-time accounting of the accident, as well as the events leading up to the accident.

Accordingly, there exists a need for a system which is able to obtain data of various traffic maneuvers leading up to a collision between two or more vehicles, as well as real time data of the accident between two or more vehicles.

### SUMMARY OF THE INVENTION

Using object detection in potentially dangerous areas (such as road crossings, intersections, streets with high pedestrian or cyclist activity) and existing vulnerable road user EBA algorithms, the events leading up to a collision, as well as the actual collision event may be recorded such that an accurate account of the accident is achieved, and local law enforcement agencies may be immediately notified.

Since EBA systems have sensors that may accurately determine the location, speed, and direction of objects (pedestrians, cyclists, etc), and may be equipped with V2x technologies and communicate with the smart city infrastructures, key information may be obtained and sent to various servers for companies to determine pre-crash scenario accidents occurring in near real-time, such that developers of safety technologies may use this information quickly implement new safety technologies or improve existing ones.

In one embodiment, the present invention is a data collection system for recording a traffic event, which includes at least one sensor operable for detecting the movement of one or more vulnerable road users in a detection area, and one or more vehicles in the detection area, at least one communication device in electrical communication with the sensor, at least one signal device in electrical communication with the communication device, and an infrastructure component, where the sensor and the communication device are connected to the infrastructure component. The infrastructure component is located near an intersection, and the communication device commands the signal device to produce at least one signal when the sensor detects at least one traffic event in the detection area.

In one embodiment, the at least one communication device is connected to the infrastructure component, where the infrastructure component may be a building, bridge, parking structure, support structure, or the like.

The signal device is used to send the signal to a law enforcement agency, alerting the law enforcement agency that an accident has occurred, or a hospital, such that an ambulance and paramedics may be sent to the location of the traffic event.

In one embodiment, the communication device records and saves data obtained by the sensor during a first predetermined time period occurring prior to the traffic event, and during a second predetermined time period occurring after the traffic event.

The traffic event may be any type of event, such as a collision between two or more vehicles, or a collision between at least one vehicle at least one vulnerable road user.

The sensor may be any type of suitable sensor, such as, but not limited to, long-range radar, short-range radar, LIDAR (Light Imaging, Detection, and Ranging), LADAR (Laser Imaging, Detection, and Ranging), camera, ultrasound, and sonar.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

The FIGURE is a perspective view of a traffic intersection having a data collection system being part of an infrastructure component, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

An example of a data collection system for obtaining information regarding vehicle accidents is shown in the FIGURE generally at 10. There are also several vulnerable road users (VRUs), shown generally at 12, travelling near an intersection, shown generally at 14. More specifically, there are two vulnerable road users 12A,12B attempting to cross the intersection 14 at a cross-walk, shown generally at 16. A first vehicle 18A is stopped near the cross-walk 14, a second vehicle 18B is approaching the first vehicle 18A, and a third vehicle 18C is moving towards the intersection 16.

The data collection system 10 includes some type of infrastructure component, which in this embodiment is a post, shown generally at 20, having at least one type of detection device, which in this embodiment is a sensor 22, at least one communication device 24, and at least one signal device 26. While in this embodiment, the infrastructure component is the post 20, it is within the scope of the invention that the data collection system 10 may include any other type of infrastructure component, such as a building, bridge, parking structure, support structure, or the like. In this embodiment, the sensor 22, communication device 24, and the signal device 26 are integrated into a single component, but it is within the scope of the invention that the sensor 22, communication device 24, and the signal device 26 may be separate components in different locations. The sensor 22 in this embodiment is able to detect objects in a detection area, shown generally at 22A, such that various traffic events, such as accidents, are detected. In one embodiment, the sensor 22 is a long-range radar sensor 22, but it is within the scope of the invention that other types of sensors maybe used, such as, but not limited to LIDAR (Light Imaging, Detection, and Ranging), LADAR (Laser Imaging, Detection, and Ranging), other types of radar, a camera, ultrasound, or sonar.

In the example shown in the FIGURE, the first vehicle 18A is stopped at the intersection 14, and the second vehicle 18B has collided with the first vehicle 18A, with the impact being shown by the icon generally at 30. When the second vehicle 18B has collided with the first vehicle 18A in the detection area 22A, the collision 30 is detected by the sensor 22, and the sensor 22 sends a signal to the communication device 24, and the communication device 24 commands the signal device 26 to send a signal, shown generally at 28, to a local law enforcement agency, represented by icon 32, such that the local law enforcement agency 32 may respond appropriately. The signal 28 may also be sent to one or more local hospitals, such that an ambulance and paramedics may be sent to the location of the collision between the vehicles 18A,18B, if necessary.

The system 10 of the present invention also includes a data collection function. The sensor 22 is continuously detecting data regarding the location, as well as speed and direction of each vehicle 18A,18B,18C and the location, speed, and direction of each VRU 12A,12B. The data for a specific time period is recorded, and stored in the communication device 24 for a predetermined period of time. In one embodiment, the time period is five minutes, but longer or shorter time periods may be used. The data may also be recorded using a time period that is a continuous moving window, such that data is recorded in real time, and the most recent data is what is stored in the communication device 24. For example, if data is collected for the most recent five-minute time period, the data is continuously changed. The oldest data is continuously deleted while new data is continuously collected. The communication device 24 therefore always has data representing all of the events that have occurred in the detection area 22A during the most recent five-minute time period.

In one embodiment, the data collection function may include two predetermined time periods. A first predetermined time period may represent data collected for a time period prior to the traffic event, and a second time period may represent data collected for a time period after the traffic event. This allows for all of the conditions which may have resulted in the traffic event and the resulting reaction by other drivers and pedestrians to the traffic event to be recorded and stored for analysis.

If no accidents or collisions occur in the detection area 22A, the data is deleted, and new data is collected. If an accident, or collision occurs, the data regarding the location, as well as speed and direction of each vehicle 18A,18B,18C and the location, speed, and direction of each VRU 12A,12B is stored, and not deleted. In the example shown in the FIGURE, the second vehicle 18B has collided with the first vehicle 18A. The data regarding the location, speed, and direction of each vehicle 18A,18B for a predetermined time leading up to the collision (which in this example is five minutes), and for a predetermined time period after the collision is recorded and stored. The data regarding each of the vehicles 18A,18B involved in the accident, and data regarding the vehicle 18C not involved in the accident, as well as the information about the location, speed, and direction of any other vehicles or VRUs 12 may be included as well. All of this information may be sent by the signal device 26 to various servers owned by companies which review the circumstances around the location of the collision, and the events leading up to the collision. The data is then analyzed and used for developing new safety technologies, or improving existing ones.

In one embodiment, the communication device 24 is a dedicated short range communication (DSRC) device 24, or a 5g communication device 24, but it is within the scope of the invention that other types of communication devices maybe used.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a data collection system, including:
at least one sensor operable for detecting one or more objects in a detection area;
at least one communication device in electrical communication with the at least one sensor; and
at least one signal device in electrical communication with the communication device;
wherein the communication device commands the at least one signal device to send a signal to at least one agency when a traffic event has occurred in the detection area.

2. The apparatus of claim 1, wherein the at least one signal device sends the signal to a law enforcement agency, alerting the law enforcement agency that an accident has occurred.

3. The apparatus of claim 1, wherein the at least one signal device sends the signal to a hospital, alerting the hospital that an accident has occurred.

4. The apparatus of claim 1, the at least one sensor being one selected from the group consisting of long-range radar, short-range radar, LIDAR (Light Imaging, Detection, and Ranging), LADAR (Laser Imaging, Detection, and Ranging), camera, ultrasound, and sonar.

5. The apparatus of claim 1, wherein at least one component of the data collection system is part of an infrastructure component, and the communication device is connected to the infrastructure component.

6. The apparatus of claim 1, further comprising a predetermined time period, wherein the communication device records and saves data obtained by the at least one sensor for the predetermined time period prior to the traffic event.

7. The apparatus of claim 1, the at least one traffic event further comprising a collision between two or more vehicles.

8. The apparatus of claim 1, the at least one traffic event further comprising a collision between at least one vehicle at least one vulnerable road user.

9. A data collection system for recording a traffic event, comprising:
at least one sensor operable for detecting the movement of one or more vulnerable road users in a detection area, and one or more vehicles in the detection area;
at least one communication device in electrical communication with the at least one sensor;
at least one signal device in electrical communication with the communication device;
an infrastructure component, the at least one sensor connected to the at least one infrastructure component; and
an intersection, the infrastructure component located near the intersection;
wherein the communication device commands the at least one signal device to produce at least one signal when the at least one sensor detects at least one traffic event detected in the detection area.

10. The warning system of claim 9, wherein the at least one communication device is connected to the infrastructure component.

11. The warning system of claim 9, wherein the at least one signal device sends the signal to a law enforcement agency, alerting the law enforcement agency that an accident has occurred.

12. The warning device of claim 9, wherein the at least one signal device sends the signal to a hospital, alerting the hospital that an accident has occurred.

13. The warning system of claim 9, further comprising:
a first predetermined time period occurring prior to the traffic event; and
a second predetermined time period occurring after the traffic event;
wherein the communication device records and saves data obtained by the at least one sensor during the first predetermined time period and during the second predetermined time period.

14. The warning system of claim 9, the at least one traffic event further comprising a collision between two or more vehicles.

15. The warning system of claim 9, the at least one traffic event further comprising a collision between at least one vehicle at least one vulnerable road user.

16. The warning system of claim 9, the at least one sensor being one selected from the group consisting of long-range radar, short-range radar, LIDAR (Light Imaging, Detection, and Ranging), LADAR (Laser Imaging, Detection, and Ranging), camera, ultrasound, and sonar.
